(19) United States
(12) Patent Application Publication
(10) Pub. No.: US 2026/0097676 A1
(43) Pub. Date: Apr. 9, 2026

(54) IDENTIFYING AT-RISK LOW-VOLTAGE GRID ASSETS

(71) Applicant: Itron, Inc., Liberty Lake, WA (US)

(72) Inventors: Tyler Byers, Liberty Lake, WA (US); Michael Ting, Oakland, CA (US)

(21) Appl. No.: 19/045,388

(22) Filed: Feb. 4, 2025

Related U.S. Application Data
(60) Provisional application No. 63/703,807, filed on Oct. 4, 2024.

(51) Int. Cl. B60L 53/63; B60L 53/62; H02J 3/00; H02J 13/00

(52) U.S. Cl. CPC B60L 53/63; B60L 53/62; H02J 3/001; H02J 13/12

(57) ABSTRACT

Techniques for identifying at-risk low-voltage grid assets are described. At-risk transformers (and, in some examples) other devices, are identified if overloaded and actively providing power for electric vehicle (EV) charging. EV charging devices and/or EVs may be enrolled in a program wherein techniques are employed to reduce over-loading events at the at-risk devices. The techniques can involve EV charging management to reduce transformer overload. The techniques for detecting at-risk devices and enrolling EV-charging devices and/or other high-wattage devices can be used to protect transformers, secondary feeders, medium voltage lines, and substations.

### RELATED APPLICATIONS

This application claims priority to U.S. Provisional Ser. No. 63/703,807, filed Oct. 4, 2024, titled “IDENTIFYING AT-RISK LOW-VOLTAGE GRID ASSETS,” the entirety of which is incorporated herein by reference.

### BACKGROUND

Overstressed electricity grid components and devices have a higher failure rate when their overstress conditions are not recognized and mitigated. This is increasingly becoming a problem due to the demand imposed on the electricity grid due to electric vehicle (EV) charging.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components. Moreover, the figures are intended to illustrate general concepts, and not to indicate required and/or necessary elements.

FIGS. 1A and 1B are a single block diagram showing an example by which customers having electrical vehicles (EVs) are detected, transformer overload is determined, and an enrollment process is performed to obtain customer permissions to better perform EV charging in a manner that reduces transformer stress.

FIGS. 2A and 2B are a single block diagram showing an example by which customers having electrical vehicles (EVs) are detected, EV load aggregation is performed, transformer loads are compared to rated loads, and an enrollment process and user interface (UI) is provided to obtain customer permissions to better perform EV charging in a manner that reduces transformer stress.

FIGS. 3A, 3B, and 3C are a block diagram showing example structure and operation of a system to protect transformers using distributed energy resources.

FIG. 4A is a block diagram of portions of an electricity grid, showing an example system for identifying at-risk low-voltage grid assets and for transformer protection using distributed energy resources.

FIG. 4B is a block diagram of portions of an electricity grid, showing example techniques to manage solar panel and battery resources in a system for identifying at-risk low-voltage grid assets and for transformer protection using distributed energy resources.

FIG. 5 is a flow diagram showing an example method by which advanced metering infrastructure (AMI) is used to obtain data, EV load is disaggregated, transformers are compared to their rated loads, and identities of transformers having historically overloaded conditions are obtained as part of an at-risk transformer identification and protection system.

FIG. 6 is a flow diagram showing an example method by which an example system identifies at-risk low-voltage grid assets.

FIG. 7 is a flow diagram showing an example method to reduce the load of an overloaded transformer.

FIG. 8 is a flow diagram showing an example method by which customer sites may be selected and their loads managed to reduce the load of an overloaded transformer.

FIG. 9 is a flow diagram showing an example method by which EV charging patterns may be identified.

FIG. 10 is a flow diagram showing an example method by which electricity meters and the data they generate may be associated with the transformers from which the meters receive power.

FIG. 11 is a flow diagram showing an example method by which the load on a transformer may be determined.

FIG. 12 is a flow diagram showing an example method by which the load associated with EV charging may be identified.

FIG. 13 is a flow diagram showing a first example method by which an example system formulates a forecast of transformer load levels, identifies at-risk low-voltage grid assets, and controls device operations (e.g., EV chargers) to reduce transformer overloading.

FIG. 14 is a flow diagram showing a second example method to reduce transformer overloading.

FIG. 15 is a flow diagram showing a third example method by which customer sites may be selected and their loads managed to reduce transformer overloading.

FIG. 16 is a flow diagram showing a fourth example method by which customer sites may be selected and their loads managed to reduce transformer overloading.

FIG. 17 is a flow diagram showing example identification of overloading events, including existing transformer overloading, and forecasted transformer overloading.

FIG. 18 is a flow diagram showing example operation of a forecasting model, device (e.g., EV chargers and battery storage systems) scheduling, and device operation according to a schedule configured to reduce transformer overloading.

FIG. 19 is a flow diagram showing example techniques for directing operation of device(s) to reduce transformer overloading.

FIG. 20 is a flow diagram showing example techniques for indirectly managing operation of device(s) to reduce transformer overloading.

FIG. 21 is a flow diagram showing example schedule creation and device management to reduce transformer overloading.

### DETAILED DESCRIPTION

### Overview of Identifying At-Risk Low-voltage Grid Assets

The disclosure describes techniques for protecting transformers by detecting at-risk transformers and other devices, and enrolling load-consuming devices in a program wherein techniques are employed to reduce load and to thereby protect the at-risk devices. The techniques detect and enroll load-consuming devices that are served by transformers, as well as other components and systems such as, for example, secondary feeders, medium voltage lines, and substations.

### First Example System and Techniques

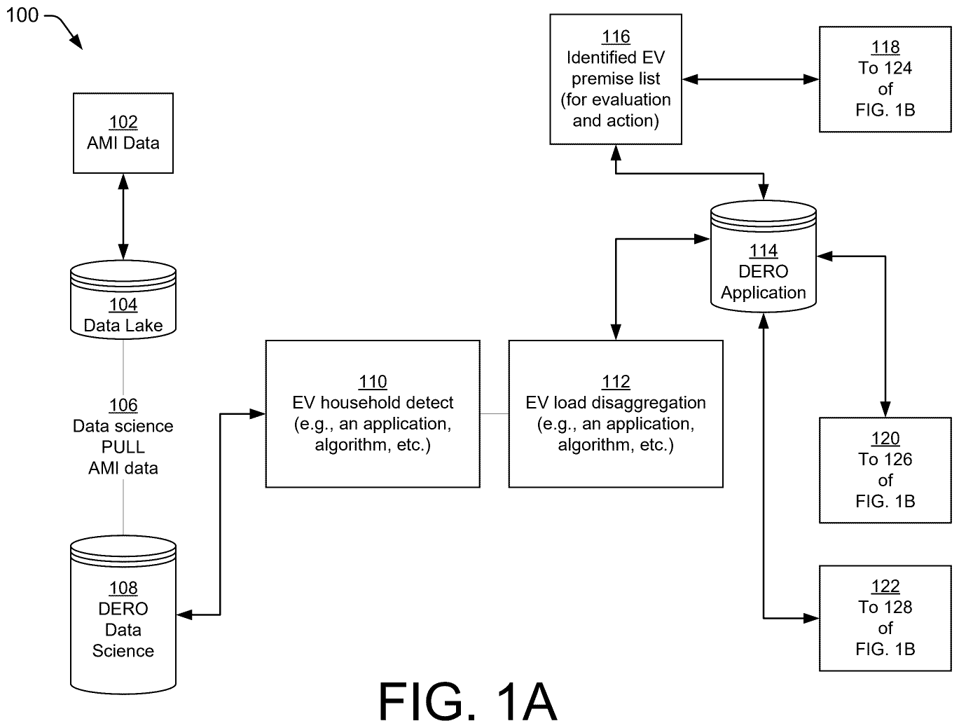

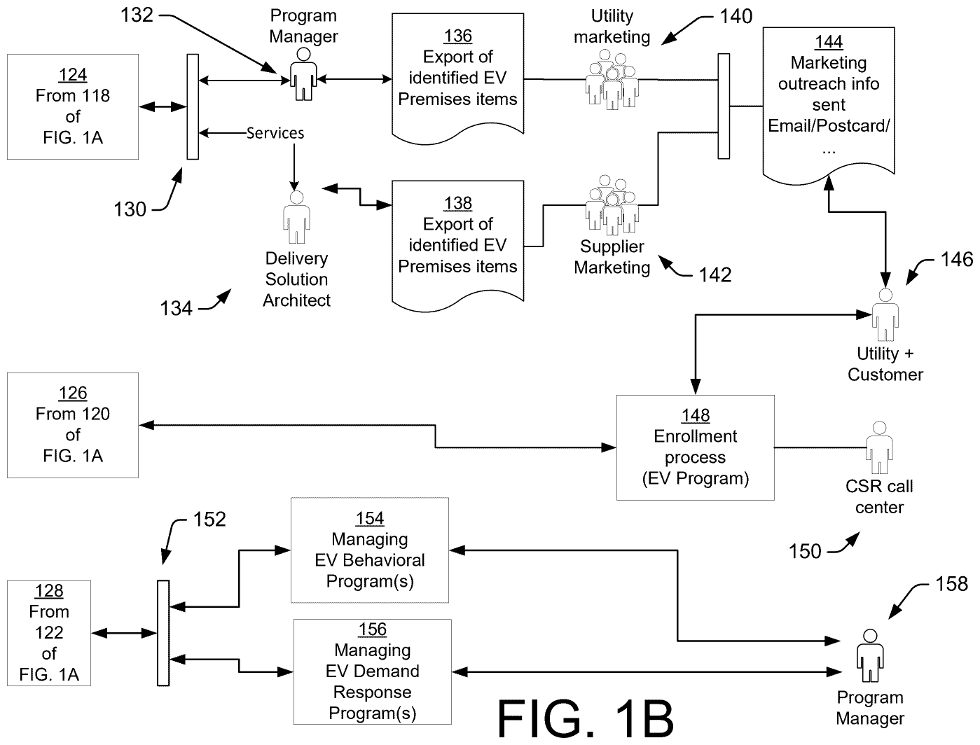

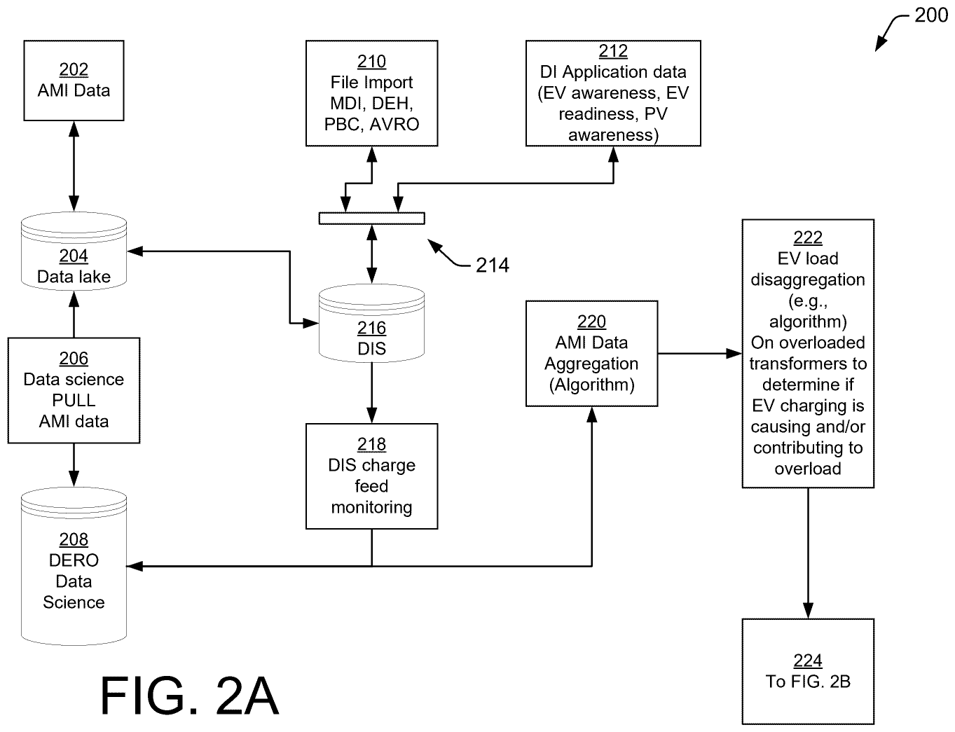

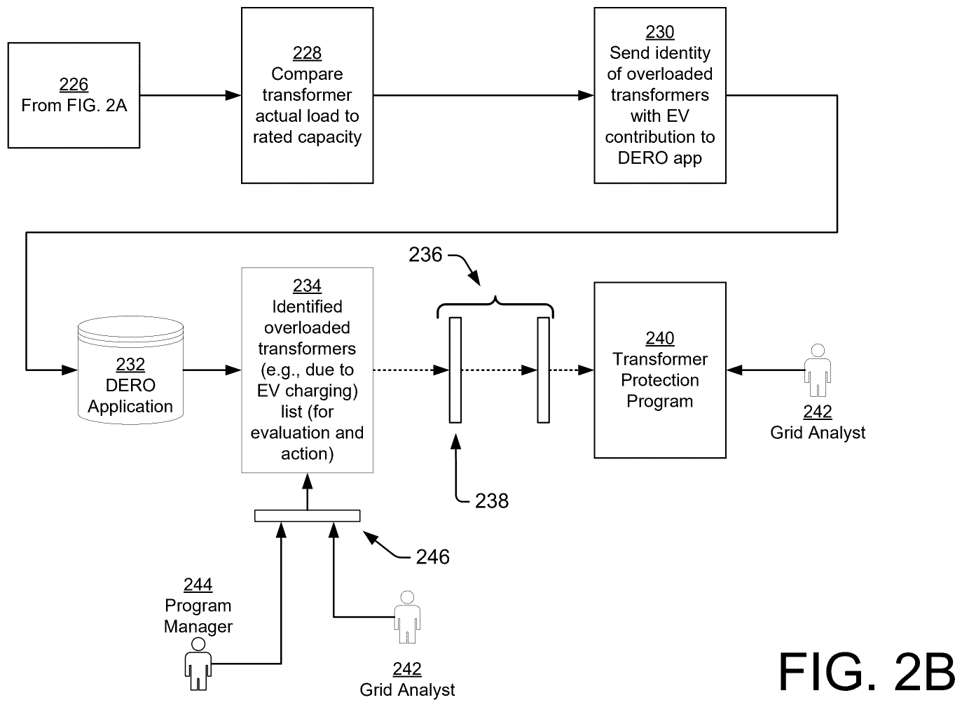

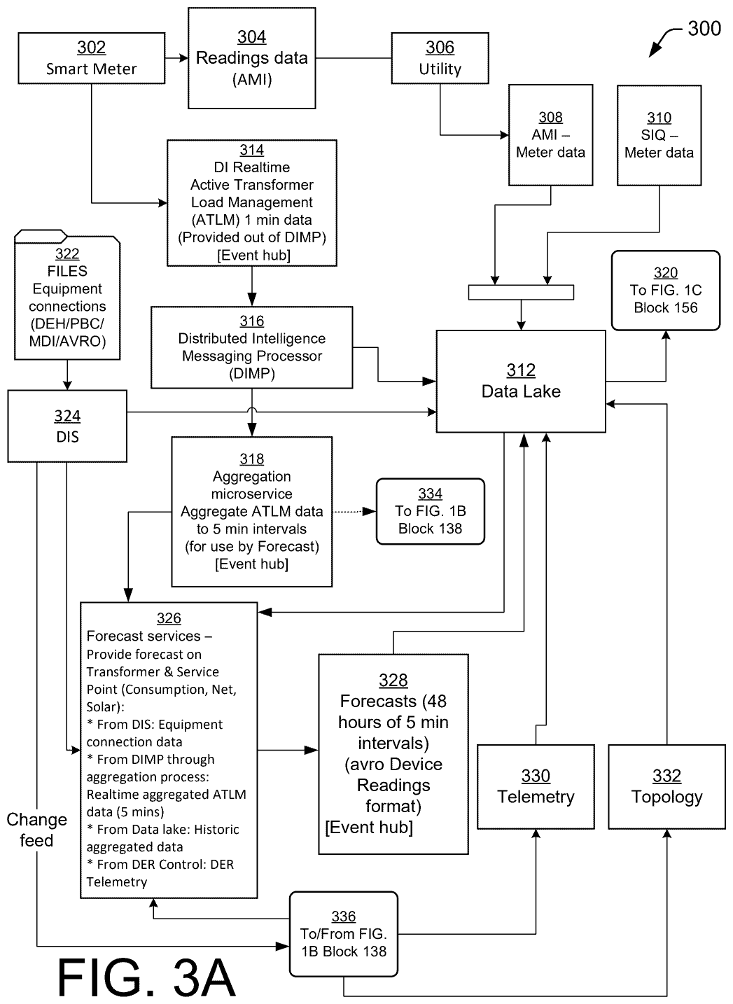

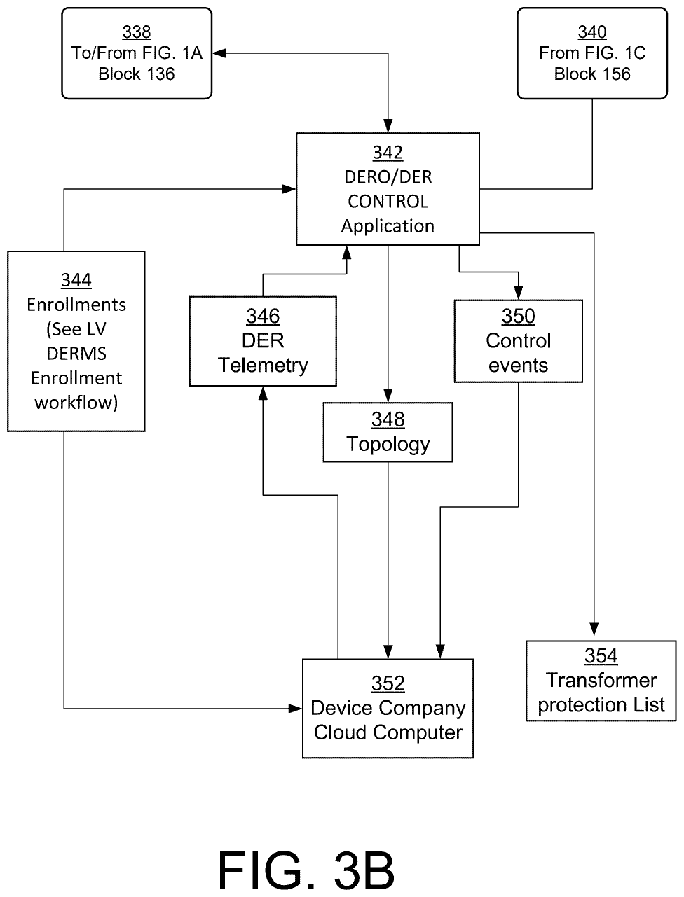

FIGS. 1A and 1B show an example by which customers having electrical vehicles (EVs) are detected, EV load disaggregation is performed, and service sites that are detected to be charging EVs may be managed differently than other sites to perform EV charging in a manner that reduces transformer stress. In some examples, an enrollment process may be performed to allow customers to opt in and/or to otherwise obtain customer permissions to manage their service sites to perform EV charging in a manner that reduces transformer stress.

FIGS. 1A and 1B show techniques for protecting transformers by detecting at-risk transformers and other devices, and enrolling such devices in a program wherein techniques are employed to protect the devices. The techniques for detecting and enrolling devices are described in the context of transformers, but the techniques described herein are also applicable to protecting other devices, components, and systems, such as secondary feeders, medium voltage lines, and substations.

AMI data may originate from multiple locations, but particularly includes distributed intelligence (DI) applications, such as those operating on smart electricity meters or other devices. In an example, data may be received from a demand-response program associated with an electrical vehicle (EV). Using the data, at-risk transformers, low-voltage devices, and medium voltage devices (e.g., devices associated with feeder lines and substations), such as those through which the EV is connected and/or is receiving power, may be identified.

In examples, the data may be processed, including data aggregation processes, and load disaggregation processes. Data may be obtained from a variety of sources, such as: DI applications on smart meters; a utility company (which may supply topology information regarding grid devices and their interconnections); advanced metering infrastructure (AMI), and others. Transformers that have experienced overload conditions (e.g., transformers operating at power levels greater than their rated power levels) are identified and examined for EV-charging activities, thereby identifying overloaded transformers that perform EV-charging. In an example, the transformer-overload conditions are transient in nature—not constant—and can be corrected by management of high-wattage load devices.

Having obtained AMI-sourced information, topology information, and load disaggregation information, transformer loads may be compared to the transformers' rated capacities. This information may be sent to an application, such as the distributed energy resource optimizer (DERO) application.

A user interface (UI) and associated functionality may be used to sort and display information, such as a prioritization of overloaded and/or at-risk transformers, and particularly transformers that are known (or suspected) of supplying EV-charging customers.

A program manager and/or a grid analyst may be utilized to reach out to EV-charging customers associated with overloaded transformers. The customers would be enrolled in a transformer-protection program. Such a program may employ techniques such as reducing scheduling-overlap of EV-charging events associated with the same transformer. Thus, neighbors may be organized by the DERO application (or other manager) to reduce the overload on the transformer shared by the neighbors. In an example, a customer outreach program 236 may involve a number of individual customer contacts 238. The customer outreach program 236 may result in agreement with the customers to enroll their EV in a charging program 240 that is designed to lessen the load and/or overload (e.g., depending on the time of day, etc.) of one or more transformers.

In an example, the DERO application can suggest a charging schedule and strategy that will result in the least possible overload amount and time for the transformer. The charging schedule may be sent to one or more devices operating on a customer's service site.

System 100 is part of an electricity supply grid providing protection to transformers by detecting at-risk transformers and other devices, and enrolling such devices in a program wherein techniques are employed to protect the device. Advanced metering infrastructure (AMI) data 102 is obtained, such as from smart electricity meters and is provided to a data lake 104 or data warehouse. In an example, the data lake 104 may be a data repository that stores, processes, and provides security to, large amounts of data. Data lakes can store semi-structured, and unstructured data, while a data warehouse may be used for more structured data. In examples, data lake(s) and/or data warehouse(s) may be used, depending on the nature of the data structures utilized. At block 106, data may be pulled, e.g., requested, by the distributed energy resource optimizer (DERO) “data science” application. The DERO data science application assists in managing and/or using the data in the data lake 104. In an example of operation of the DERO data science application, at block 110, customers with EVs and EV-charging are detected. At block 112, EV load disaggregation is performed, indicating the times and customer sites that are involved with EV charging. At block 114, the DERO application receives a list of identified EV-owning premises from 116. Blocks 118, 120, and 122 indicate points at which the block diagram continues to FIG. 1B. At block 130, data is bifurcated to a program manager 132 and a delivery solutions architect 134. At block 136, data related to premises with EVs is exported to an administrator 140. At block 138, data related to premises with EVs is exported to information department 142. The output of the administrator 140 and an information department 142 is sent at 144 as information outreach information to customers. In an example, a utility company employee 146 “registers” or “enrolls” customers in a program to manage EV-charging in a manner that will reduce transformer (and other component) stress. An example process 148 includes a call center 150, wherein customers may contact the utility company to enroll in the program, as part of process 148. Additionally or alternatively, customers may enroll in the program via a website or application. At block 152, data is bifurcated to a program of managing EV behavioral programs 154 and a program for managing EV demand and response program(s) 156. Both programs 154, 156 may be managed by one or more managers, technicians, engineers 158, or other administrators.

### Second Example System and Techniques

FIGS. 2A and 2B show an example electricity grid 200 by which customers having electrical vehicles (EVs) are detected, EV load aggregation is performed, transformer loads are compared to rated loads, and an enrollment process and user interface (UI) is provided to obtain customer permissions to better perform EV charging in a manner that reduces transformer stress. At block 202, AMI data is obtained, such as from smart electricity devices. A data lake 204 maintains and protects data in a variety of formats, data structures, etc. At block 206, a data science application pulls data from the data lake 204, which is provided to the DERO data science data-management application 208. At block 210 and 212, data files are imported, such as from MDI, DEH, PBC, and AVRO (at block 210) and distributed intelligence applications (at block 212). At block 214 the data may be merged, and delivered to the DIS 216. At block 218, data is returned to the DERO data science application for processing, and is then sent to the AMI data aggregation application (and/or algorithm) 220. At block 222 the EV load is disaggregated, and it is determined if EV charging is contributing to transformer overload. At block 224, the diagram continues at block 226 of FIG. 2B. At block 228 it is determined if transformers' actual load is greater than a rated load. At block 230, the identities of overloaded transformers are sent to the DERO application 232. At block 234, a list of overloaded transformers having an overload related to EV charging is formed. Accordingly, the list considers EV charging, transformer load, transformer load rating, and/or other factors in creating the list. The transformers on the list are potentially convertible from overloaded to acceptably loaded by better EV-charging management. A customer outreach program 236 communicates with each customer contact 238 from among a plurality of customers. A transformer protection program 240 is continued, potentially managed by a grid analyst 242. In an example, the grid analyst 242 and a program manager 244 may combine at interface 246 to assist in the identification of overloaded transformers at block 234.

### Overview of Transformer Protection Using Distributed Energy Resources

Service transformers (e.g., secondary distribution transformers) are at risk due to overloaded conditions. Accordingly, a system for controlling devices to protect transformers is disclosed. In an example, electricity meters use distributed intelligence (DI) applications to obtain high-resolution data, and to communicate with other meters on the same transformer, and to thereby manage large loads such as electric vehicle (EV) charging. The DI applications provide data, including transformer load, in an accurate and continuous manner. Forecasts are made for transformer level consumption. Control plans are sent down to individual devices to implement the controls, such as by operation of a data management tool. In an example, the control plans control the times of operation of EV supply equipment. Accordingly, the sensing is performed at the edge (of the electricity grid, e.g., at the electricity meter), and the optimization plan is generated in the cloud. Control of the plan may be effectuated by a cloud computer of the device to be controlled, such as the EV supply equipment and/or EV vehicle manufacturer. Thus, sensing is at the edge, and control is at the cloud.

A forecast is used to estimate future load. A control plan is based on the forecast, and is not reactive to the current situation. In an example, if there is a forecast for an overloaded transformer, then a control plan schedules the timing of charging activity and/or battery discharges. Forecasting load levels using advance metering infrastructure (AMI) data helps to overcome latency (in recognizing loads) and allows a response to be planned for events that are still in the future. Using a forecast, a distributed energy resource optimizer (DERO) tool can apply a proactive stance and use forecasted transformer loads (based on AMI data) to identify transformers that will likely experience long duration overloads over specific time periods.

In an example configuration, a smart meter performs power measurement operations at the “edge” of the network, while the utility company cloud computer performs forecasting and planning calculations to formulate a plan that will prevent a transformer overload. The plan is then communicated to a cloud computer of the EV-charger company, or the battery-charger company, and/or a solar generation company. The EV, battery, solar generation, or other company's cloud computer communicates with devices (that it manufactured and/or sold to the customer of the service site of the smart meter), such as by using an IP-protocol. This communication directs operation of the devices according to the plan, and maintains the load on the transformer at levels below the transformer's rating. In an example, the plan may delay some charging activity and/or discharge a battery to keep the transformer below its rating.

### Example System and Techniques

The distributed energy resource optimizer (DERO) strategy to mitigate the transformer overload conditions is to manage the loads behind the meter in a way that minimizes the frequency and duration of overloads. DERO can achieve this by: collecting location-specific signals around transformer loading; and generating control profiles (throttling, staggering, etc.) for individual devices at a location to mitigate a forecasted or existing overload situation.

### Example Operation

Step 1: Consume premise-level or transformer loading data (e.g., by operation of a smart electricity meter).

Step 2: Analyze data (e.g., by data aggregation and operation of a forecasting model).

Step 3: Determine distributed energy resource (DER) control profile (optimization model).

Step 4: Actuate DER control profile.

Step 5 Monitor/validate the results of the control actuation.

Step 6 Repeat.

Analytics Techniques: Establish a short-term rolling forecast for load for real power at the transformer. Compare to actual to rated capacity at the transformer. Calculate variance outside of established boundary (magnitude) for volume and duration triggers action. Determine optimal distributed energy Resource (or DER, examples of which include electric vehicle batteries, in-home batteries, and PV systems) control profiles needed to mitigate variance condition. Validate results of control actuation.

Technical Techniques: Manage latency from application or data warehouse in less than five minutes (from ingesting the data to detecting variance to pushing a control profile). Forecasting at transformer level, in example, may be set to approximately 12 to 24 hours ahead using 5-minute intervals.

### Example System for Transformer Protection Using Distributed Energy Resources

In an example, the techniques discussed herein with respect to the figures and claims utilize: smart meter sensing data; formulation of a forecast of transformer load levels over time; cloud processing of that data to indicate device timing (i.e., turning on and off loads to result in desired outcomes); cloud to cloud communication with device companies'cloud computers (e.g., car charger manufacturers and/or solar panel manufacturers and/or battery-charger manufacturers), which in turn communicate with devices that operate EV-chargers, solar panels, battery chargers, etc.

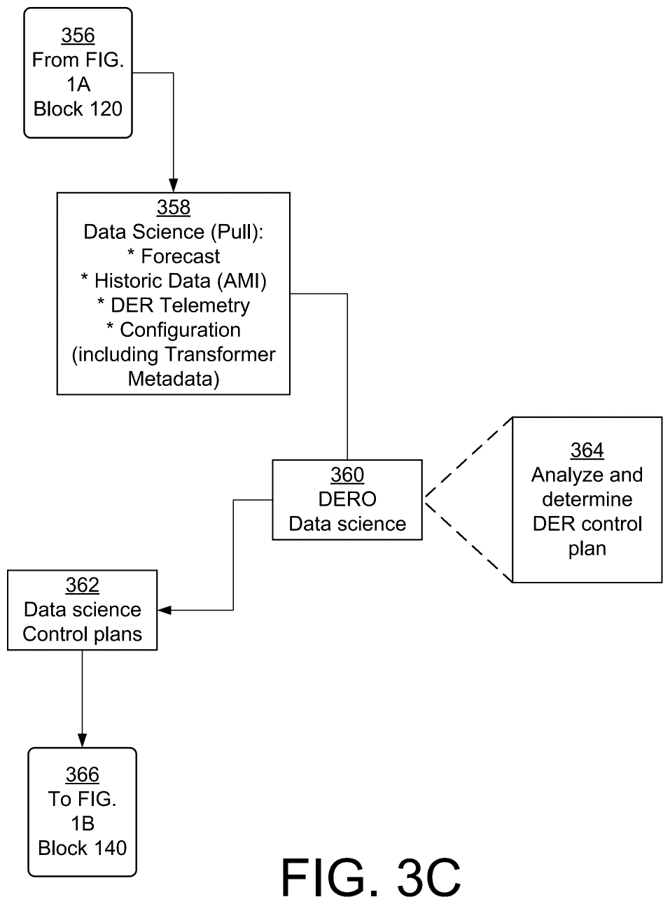

FIGS. 3A, 3B, and 3C show example structure and operation of a system 300 to protect transformers using distributed energy resources. Referring to FIG. 3A at block 302, a smart electricity meter provides meter readings (e.g., a time-series of voltage and current measurements), such as AMI data 304 to a utility company 306. Additionally, the smart metering device provides distributed intelligence (DI) real time active transformer load management (ATLM) data 314 to a distributed intelligence massaging processor (DIMP) 316. AMI metering data 308 is sent by the utility company 306 to a data lake 312. Additionally, Sensor IQ (SIQ) metering data 310 is sent to the data lake 312. Data leaves the data lake at block 320, and is discussed further in FIG. 3B. An aggregation microservice 318 receives output sent by the DIMP 316 and continues from FIG. 3A to FIG. 3B at block 334. The aggregation microservice 318 sends data to the forecast services application 326.

The forecast services application 326 provides a forecast on transformer and service point consumption, or net consumption if solar power is produced. The forecast services application 326 receives input: from device information service (DIS) 324, including equipment connection data and topology data; from DIMP 316 through an aggregation microservice 318, e.g., real time aggregated ATLM data; from the data lake 312, including historic aggregated data; and from DER Control, including DER telemetry. Additionally, input is received (via block 336) from 338 from FIG. 3B.

At block 322, files showing equipment connections and/or network topology are sent to DIS 324. Output of the DIS 324 is sent to locations including the data lake 312, forecast services application 326, and to a location in FIG. 3B at block 336.

Forecasts 328 may cover a 48-hour period at 5-minute intervals, and are sent by the forecast services application 326 to the data lake 312. In a further example, forecasts may also cover a 12-, 24-, 36- or 72-hour period, at 5-, 15-, 30-, or 60-minute intervals based on selected configurations and input data frequencies.

Telemetry 330 and topology 332 are received at block 336 from DERO/DER control application 342 via 338 of FIG. 3B.

Referring to FIG. 3B at block 338, data from the DIS 324 is received via block 336. At block 340, data is received from the data science control plan 364. The data received at blocks 338, 340 passes to the DERO/DER control application 342, which creates the transformer protection list 354. The control application 342 utilizes DER telemetry 346, and produces topology data 348 and control events 350. The topology data 348, control events 350, and enrollments data 344 are received at the device company cloud computer 352. A service (e.g., a DER service using the IEEE 2030.5 protocol) 352 sends DER telemetry 346 to the control application 342.

Referring to FIG. 3C at block 356, data from the data lake 312 is received at the data science application 358. The data science application 358 combines input from the forecast, historic AMI data, DER telemetry, and configuration (e.g., transformer metadata). The data science application 358 sends data to the DERO data science application 360. The DERO data science application outputs control plans 362, which are sent to the DERO control application 342. At data science control plan 364 (which may be a part of data science application 360), DER control plan is analyzed and determined.

### Example System for Identifying and Protecting At-Risk Assets

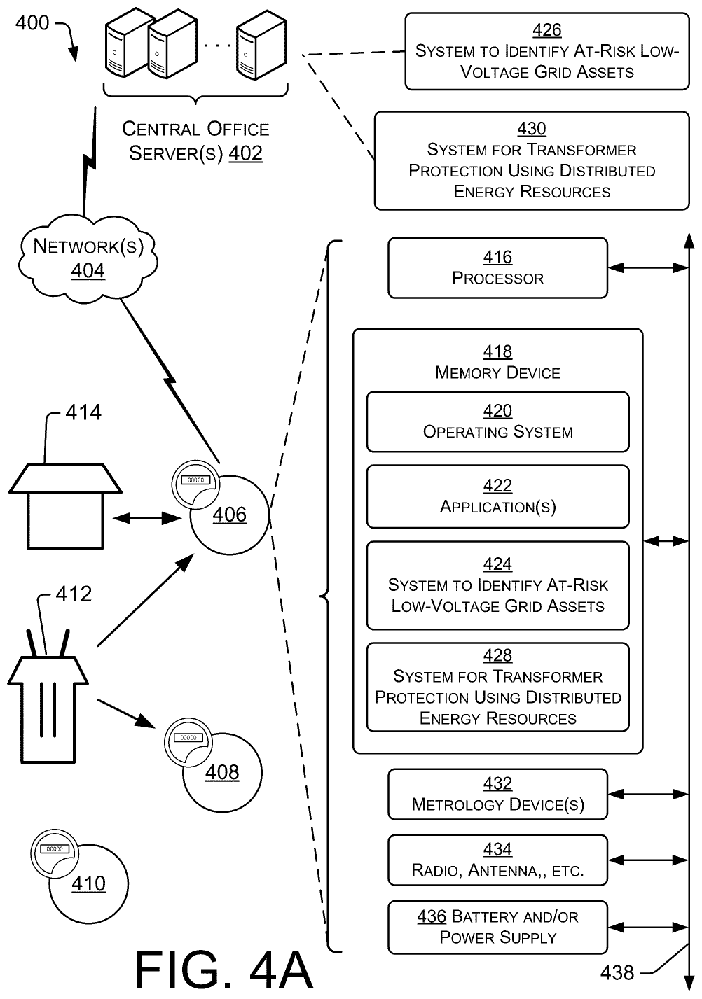

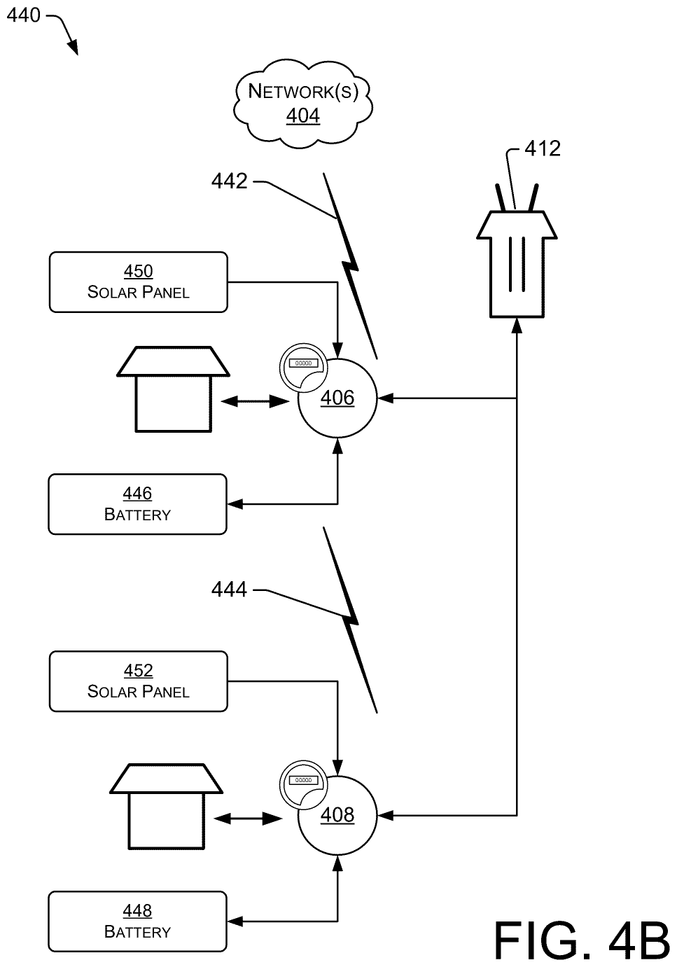

FIG. 4A shows an electricity grid 400 that includes an example system for identifying at-risk low-voltage grid assets. In the example, server(s) 402 may be associated with a utility company, a third-party provider, a cloud data system, or other computing devices. The server(s) 402 communicate over one or more network(s) 404 with a plurality of smart metering devices 406, 408, 410. In the example shown, smart metering device 406 receives power from a transformer 412, and provides measured or metered power and energy to a customer 414. Smart metering device 408 also receives power from the transformer 412, and serves a different customer (not shown). Smart metering device 410 receives power from a different transformer (not shown).

In the example, the smart metering device 406 includes a processor 416 in communication with a memory device 418. The memory device 418 may include an operating system 420 and a number of applications 422 and/or other programs, such as subroutines, drivers, utilities, and/or other software.

A system 424 may be a software program configured to identify at-risk low-voltage grid assets, such as transformers. While the system 424 is located on the smart metering device 406, a similar system 426 could be located on the server(s) 402. In a further alternative, systems 424, 426 may be located on both the server(s) 402 and the smart metering device 406. In this alternative, some of the processing functionality would be performed at each location. In an example, the available bandwidth of the network(s) 404 may determine which functions should be performed at each location, or which location should perform all of the functions.

Additionally, the smart metering device 406 may include metrology device(s) 432, a radio 434, and a battery 436 or other power supply and/or voltage-regulation device. A bus 438 or other connectivity device (e.g., a wiring harness, etc.) may be used to provide power and communications paths between the devices of the smart metering device 406.

A system 428 may be a software program configured to control the operation of high-wattage devices at service sites, and to thereby mitigate or prevent transformer overload events. In an example, high-wattage devices include electric vehicle (EV) chargers. Control over the times of operation of EV chargers, including their wattage during operation, and/or other factors, the overloading events of transformers may be reduced. In a manner similar to the systems 424 and 426, the system 428 is located on smart metering device 406, while the system 430 is located on the server(s) 402. Accordingly, some or all the functionality of the systems 428, 430 may be contained in either location. Similarly, both systems may be present and act in a cooperative manner, or only one of the systems may perform transformer-overload event-mitigation.

### Example Techniques to Identify and Protect Against Transformer Overload

FIG. 4B shows portions 440 of an electricity grid and illustrates example techniques to manage transformer, battery, and/or solar power resources in a system for identifying at-risk low-voltage grid assets and for transformer protection using distributed energy resources. The example techniques protect transformer overload and also allow for greater a quantity of energy to be provided over time by smoothing the power levels provide by the transformer. Accordingly, in some instances, individual customer consumption may increase and/or a number of customers served by the transformer may increase, while reducing transformer overloading events.

In the example of FIG. 4B, two electricity meters 406, 408 receive electricity from the same transformer 412. The electricity meters 406, 408 communicate through respective radio frequency (RF) signals 442, 444, with a head end device such as servers 402 over network 404. The electricity meters 406, 408 may also communicate with each other, to thereby implement a localized grid management system.

Battery charging and discharging may be controlled by the localized grid management system. In an example, the electricity meters attached to a transformer measure transformer load (e.g., based on a totalized load measured by all meters). When the transformer is overloaded, electricity meters associated with batteries that are sufficiently charged (e.g., meter 406 and battery 446) may discharge their respective batteries, thereby reducing or eliminating the transformer overload. The batteries may later be recharged when a reduced transformer load indicates. Accordingly, the service sites associated with electricity meters 406, 408 charge the batteries 446, 448, respectively, when the load on the transformer 412 is sufficiently low.

In the example, one or both of the batteries 446, 448 may be configured as a battery energy storage system (BESS), which may be charged, discharged, and controlled by the localized grid management system based on cooperative actions by smart electricity meters and respective battery storage systems.

In example operation, load management at the transformer power level is performed to prevent transformer overloading. In one aspect, the batteries 406, 408 are discharged to reduce that transformer's overload. The discharge may be performed responsive to information obtained by electricity meters attached to a transformer. The batteries, their respective electricity meters, and/or the servers 402 (as seen in FIG. 4A) may monitor local grid conditions, including transformer load. Transformer load may be calculated as the sum of the loads (i.e., power) measured by each of the electricity meters associated with customer sites served by the transformer. During periods of transformer overload, discharge of the batteries helps to lessen transformer load. During periods of lower transformer load, the batteries 406, 408 may be recharged. Accordingly, localized load management (at the electricity meter and transformer level) may be performed to prevent transformer overloading.

In a further example, solar power from the solar panels 450, 452 may be used to charge the batteries 446, 448. And in a still further example, during occasional power disruptions on the electricity grid, the batteries 446, 448 can be used for emergency power at their respective service sites.

### Example Methods for Identifying At-Risk Low-Voltage Grid Assets

In some examples, the techniques discussed herein (e.g., for identifying at-risk low-voltage grid assets such as transformers) may be implemented by one more processors (e.g., processor 416 of FIG. 4A) accessing software defined on one or more memory devices (e.g., memory device 418 of FIG. 4A). The processor(s) and memory device(s) may be located on a smart utility meter and/or a cloud-based server (e.g., a server of a utility company). If the functionality is distributed, portions of the software may reside on each of the smart utility meter and the server.

In other examples of the techniques discussed herein, the methods of operation may be performed by one or more application specific integrated circuits (ASIC) or may be performed by a general-purpose processor utilizing software (e.g., comprising computer-executable or processor-executable statements to perform actions) defined in computer readable media. In the examples and techniques discussed herein, the memory may comprise computer-readable media and may take the form of volatile memory, such as random-access memory (RAM) and/or non-volatile memory, such as read only memory (ROM) or flash RAM. Computer-readable media devices include volatile and non-volatile, removable, and non-removable media implemented in any method or technology for storage of information such as computer-readable instructions, data structures, program modules, or other data for execution by one or more processors of a computing device. Examples of computer-readable media include, but are not limited to, phase-change memory (PRAM), static random-access memory (SRAM), dynamic random-access memory (DRAM), other types of random access memory (RAM), read-only memory (ROM), electrically erasable programmable read-only memory (EEPROM), programmable read-only memory (PROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transitory medium that can be used to store information for access by a computing device.

As defined herein, computer-readable media includes non-transitory media. Computer-readable media does not include transitory media, such as modulated data signals and carrier waves, and/or other information-containing signals.

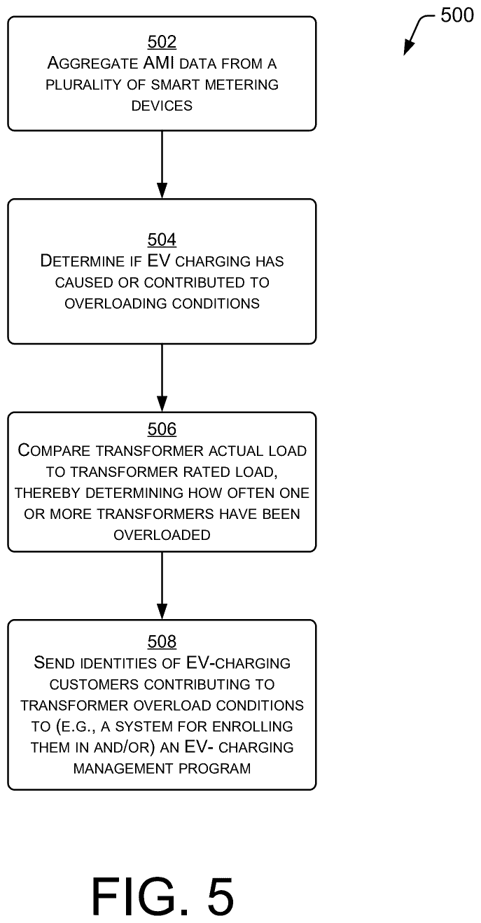

FIG. 5 shows an example method 500 by which advanced metering infrastructure (AMI) is used to obtain data, EV load is disaggregated, transformers are compared to their rated loads, and identities of overloaded transformers are obtained as part of a transformer protection system. At block 502, AMI data is aggregated from a plurality of smart metering devices. At block 504, EV load disaggregation is performed, thereby examining transformers to determine if EV charging is present on each or any transformers, and if the EV charging is causing and/or contributing to an overload. At block 506, transformer actual load is compared to transformer rated load, thereby determining if each transformer is overloaded. At block 508, the identities of overloaded transformers which support one or more EV-charging customers is sent to a program for EV-charging mitigation, management, and/or other change. Accordingly, EV-charging is lessened as a cause for transformer overload.

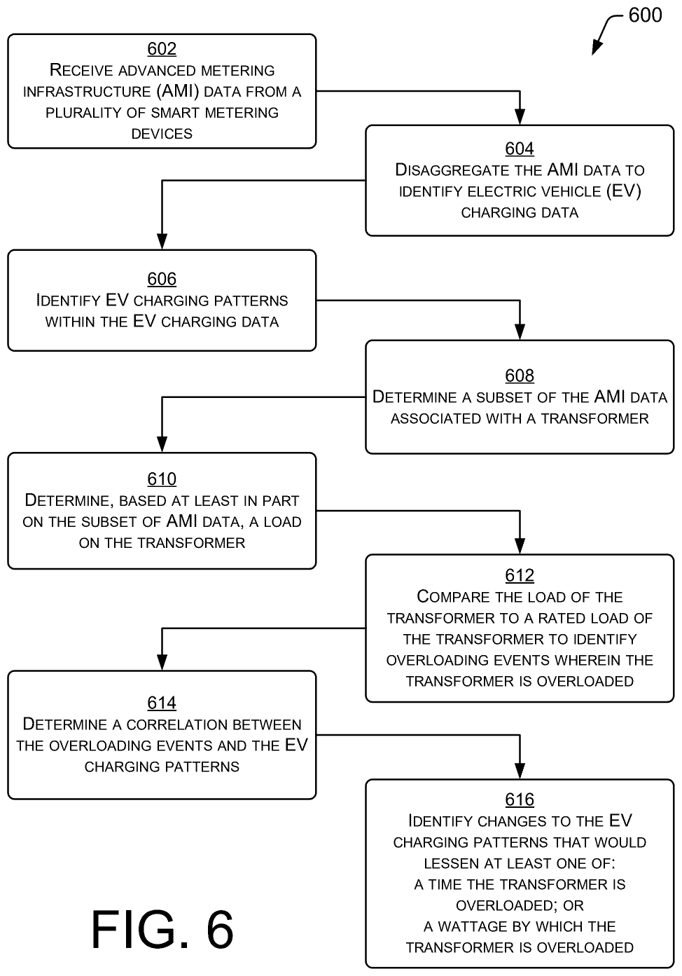

FIG. 6 shows an example method 600 to implement a system for identifying at-risk low-voltage grid assets. In the example, AMI data from a plurality of smart metering devices is collected and disaggregated to identify EV charging data and EV charging patterns within the charging data. A subset of the AMI data associated with a single transformer is identified, and the load indicated by the AMI data is compared to the rated load of the transformer. In overloaded transformers, a correlation is determined between EV charging and overloading. Changes are identified, which cause the (changed and/or adjusted) EV charging patterns to mitigate and/or eliminate the overloading conditions at the transformer.

At block 602, advanced metering infrastructure (AMI) data is received from a plurality of smart metering devices. In the example of FIG. 4A, the smart metering devices 406-410 share AMI data and/or send the data to the server(s) 402. At block 604, the AMI data is disaggregated to identify electric vehicle (EV) charging data. The disaggregation distinguishes EV charging data from other data, such as loads caused by appliances, lighting, etc. In some cases, EV charging data is distinguished by load, times of operation, and even the characteristics of certain types or brands of EV charger devices. At block 606, EV charging patterns are identified within the EV charging data. In some cases, regular schedules of EV drivers result in regular EV charging times, power levels, and/or energy totals. At block 608, a subset of the AMI data associated with a transformer is determined. In an example, the topology of the electricity grid (and relationships between particular smart metering devices and particular transformers) can be used to logically group the AMI data associated with each transformer. At block 610, a load on the transformer it is determined. In an example, the load may be the sum of the subset of AMI data. At block 612, the load of the transformer is compared to a rated load of the transformer to identify overloading events wherein the transformer is overloaded. The times, durations, wattage, and/or other factors may be used to determine the severity of the overload. At block 614, a correlation is determined between the overloading events and the EV charging patterns. In some examples, EV charging episodes may be a substantial factor in transformer overload. At block 616, advantageous changes to the EV charging patterns are identified and/or made. In an example, the new or changed EV charging patterns should include changes designed to lessen at least one of: a time the transformer is overloaded; or a wattage by which the transformer is overloaded. Techniques such as staggering the EV charging related to the transformer may be useful, particularly where several customers have several EVs and EV supply equipment. Throttling one or more EV supply equipment may slow charging (e.g., pushing some charging activity into the very early morning hours), but may result in a decrease in transformer overloading.

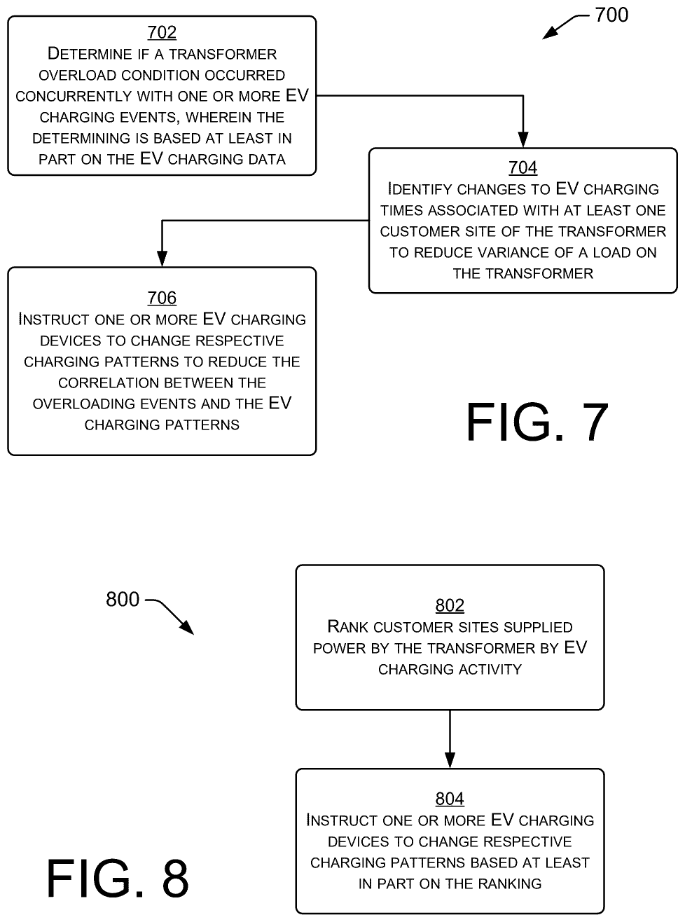

FIG. 7 shows an example method 700 to reduce the load of an overloaded transformer. The techniques of method 700 may be combined with other methods described herein. At block 702, it is determined if a transformer overload condition occurred concurrently with an EV charging event. In an example, the determining is based at least in part on the EV charging data. If the overload condition occurred concurrently with the EV charging event, changing EV charging times may obviate the overloading. At block 704, changes to EV charging times—associated with at least one customer site of the transformer—are identified. The changes reduce the variance of a load on the transformer. In an example, a smooth load that is below the transformer rated load is preferable to alternates above and below the rated load. At block 706, one or more EV charging devices are instructed to change respective charging patterns to reduce the correlation between the overloading events and the EV charging patterns.

FIG. 8 shows an example method 800 by which customer sites may be selected and their loads managed to reduce the load of an overloaded transformer. At block 802, customer sites supplied power by the transformer are ranked according to levels of EV charging activity. This identification indicates where changes to EV charging patterns may be most effective. At block 804, one or more EV charging devices are instructed to change respective charging patterns based at least in part on the ranking. In an example, parallel charging of two EVs may be replaced by sequential charging of the two EVs.

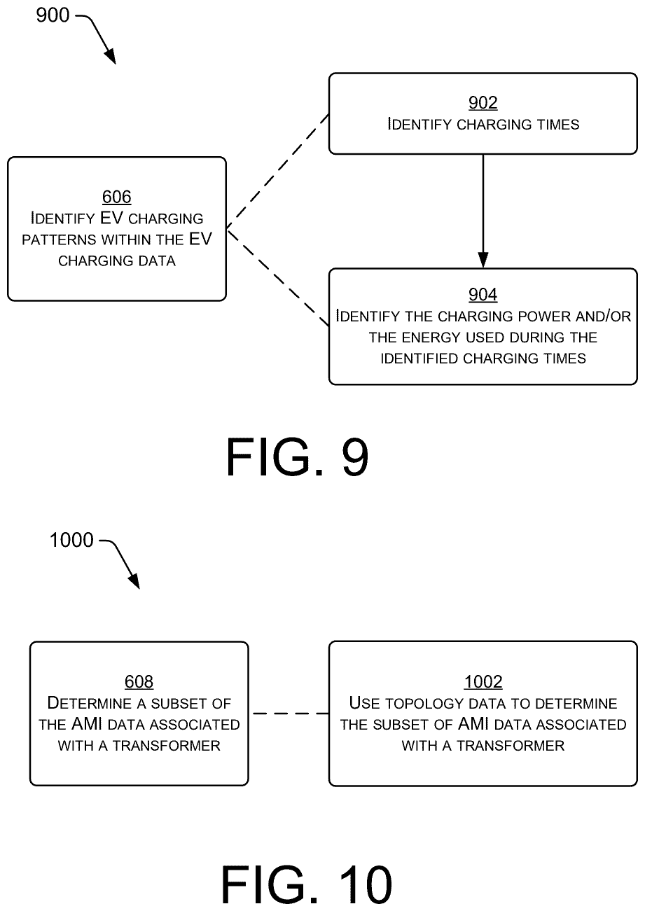

FIG. 9 shows an example method 900 by which EV charging patterns may be identified. The method 900 shows an example by which block 606 of the method 600 of FIG. 6 may be performed. Block 606 shows an example of the identification of EV charging patterns within the EV charging data. At block 902, charging times of EV at a service site are identified. In an example, the times of charging are part of the example charging patterns. At block 904, the charging power levels and/or the energy totals used during the identified charging times are identified, input, and/or calculated, etc. Accordingly, the instantaneous power and/or the overall energy of one or more charging events are part of the example charging patterns.

FIG. 10 shows an example method 1000 by which electricity meters may be associated with the transformers from which they receive power. The method 1000 shows an example by which block 608 of the method 600 of FIG. 6 may be performed. Block 608 shows an example by which a subset of the AMI data associated with a transformer is determined. At block 1002, topology data is used to determine the subset of AMI data associated with a transformer. By using the topology data, the smart metering devices receiving power from the transformer may be identified, and the aggregated AMI data of those devices may be used to determine a load of the transformer at the times measurements were made resulting in the data.

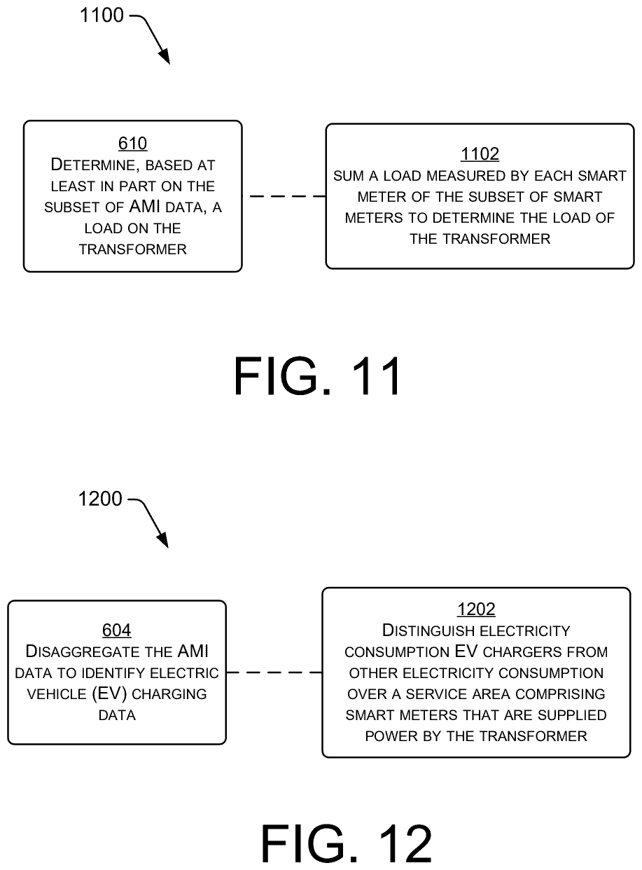

FIG. 11 shows an example method 1100 by which the load on a transformer may be determined. The method 1100 shows an example by which block 610 of method 600 of FIG. 6 may be performed. SIQ metering data 310 shows example techniques to determine—e.g., based at least in part on a subset of AMI data—a load on the transformer. At block 1102, a load measured by each smart meter of the subset of smart meters is summed to determine the load of the transformer. Thus, the load of the transformer is known based on the summation of the loads of the smart electricity meters to which the transformer sends power. In an alternative, if a smart transformer is used, the smart transformer may be able to determine its own load.

FIG. 12 shows an example method 1200 by which the load associated with EV charging may be identified. The method 1200 shows an example by which block 604 of method 600 of FIG. 6 may be performed. Block 604 shows example disaggregation of AMI data to identify electric vehicle (EV) charging data. At block 1202, disaggregation techniques are used to distinguish electricity consumption by EV charging from other electricity consumption over a service area comprising smart meters that are supplied power by the transformer.

### Example Methods for Transformer Protection Using Distributed Energy Resources

Example methods to protect a transformer from overload are described. In an example, power consumption is sensed by operation of a smart electricity meter at a service site supplied by the transformer. AMI data from the smart meter (and other meters also supplied by the transformer) is used to formulate a forecast of load levels at the transformer over time. A strategy to control timing of operation of one or more DER devices at the service site is determined, based on the forecast. The strategy to control timing is used to control at least one device at the service site, thereby keeping the load of the transformer under its rated load. In an example, the at least one device is an electric vehicle, and its charging is controlled via control commands to its onboard computer system.

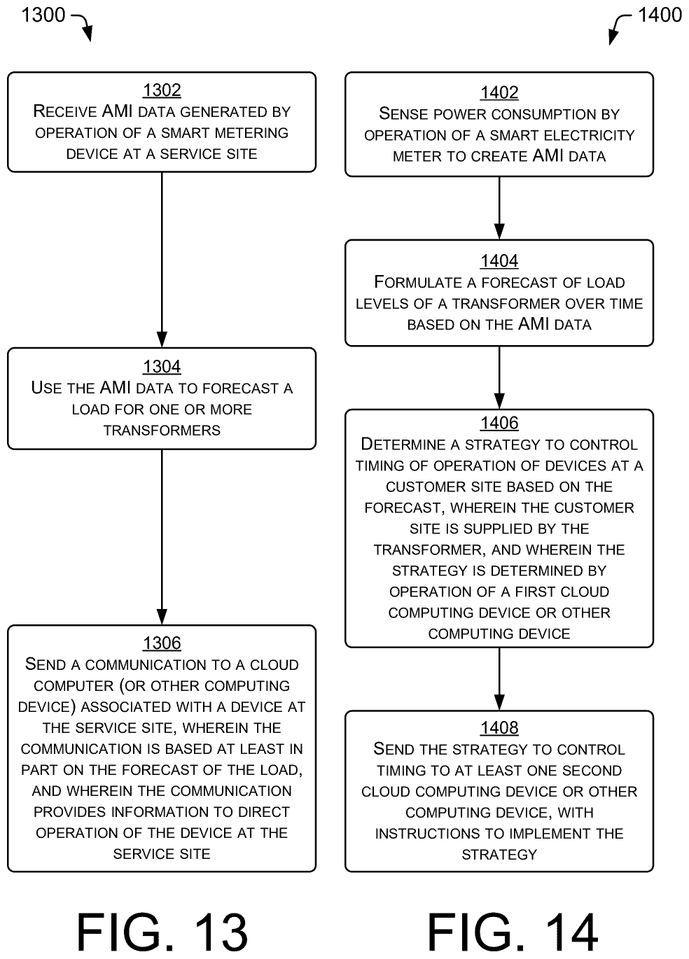

FIG. 13 shows an example method 1300 by which a transformer is protected from an overload event or condition. At block 1302, AMI data is received. The AMI data is generated by operation of a smart metering device at a service site. At block 1304, the AMI data is used to forecast a load for one or more transformers. At block 1306, a communication is sent to a cloud computer associated with a device at the service site. The communication is based at least in part on the forecast of the load, and provides information to direct operation of the device at the service site. By operating the device (e.g., an electric vehicle supply equipment) at appropriate times, the transformer load is kept below its rated load.

FIG. 14 shows a second example method 1400 by which a transformer is protected from an overload event or condition. At block 1402, power consumption is sensed by operation of a smart electricity meter to create AMI data. At block 1404, a forecast of load levels of a transformer over time is formulated, based on the AMI data. At block 1406, a strategy to control timing of operation of device(s) at a customer site is determined, based on the forecast. The customer site is supplied by the transformer, and the strategy may be determined by operation of a first cloud computing device. At block 1408, the strategy to control timing is sent to at least one second cloud computing device, with instructions to implement the strategy. The strategy operates one or more device (e.g., electric vehicle supply equipment) at appropriate times. This operation keeps the transformer load below its rated load.

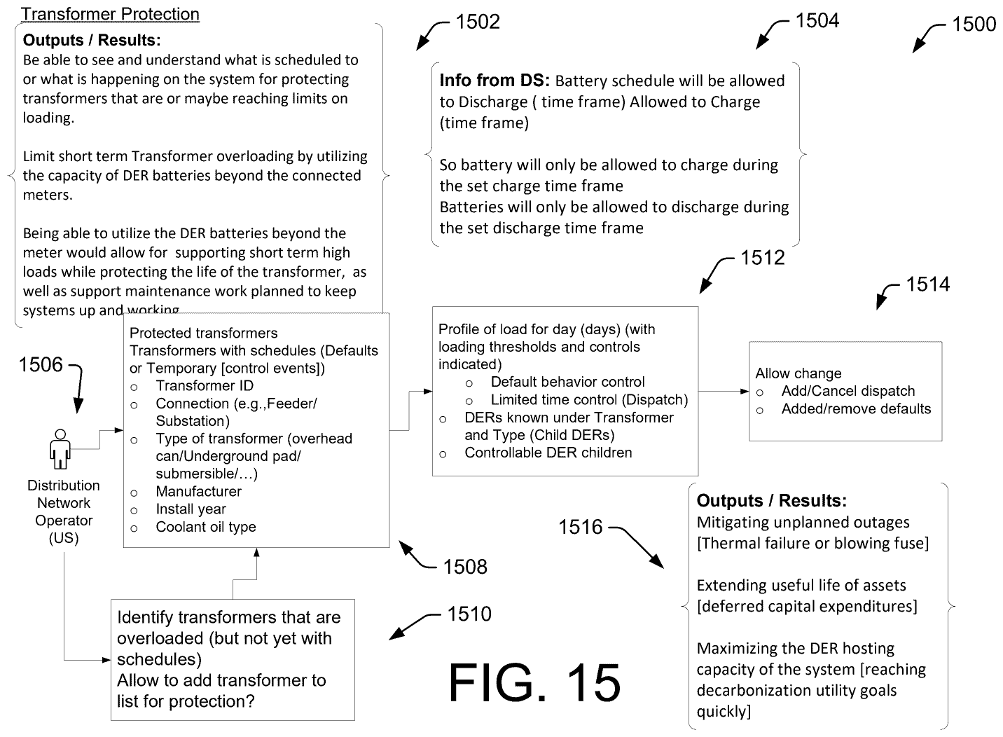

FIG. 15 shows a third example method 1500, and particularly showing information and relationships between the elements of the information. At block 1502, aspects of transformer protection are discussed. At block 1504, aspects of battery charging and discharging are discussed. At block 1506, a distribution network operator provides input to blocks 1508 and 1510. At block 1508, protected transformers and their identification are discussed. At block 1510, overloaded transformers not yet having scheduled device management (to thereby manage transformer load) are described. At block 1512, loading thresholds and controls are described. At block 1514, changes are described. In an example, the distribution network operator has the option of manually allowing or manually overriding the automated schedules and defaults as a configuration option. At block 1516, outputs and results are described.

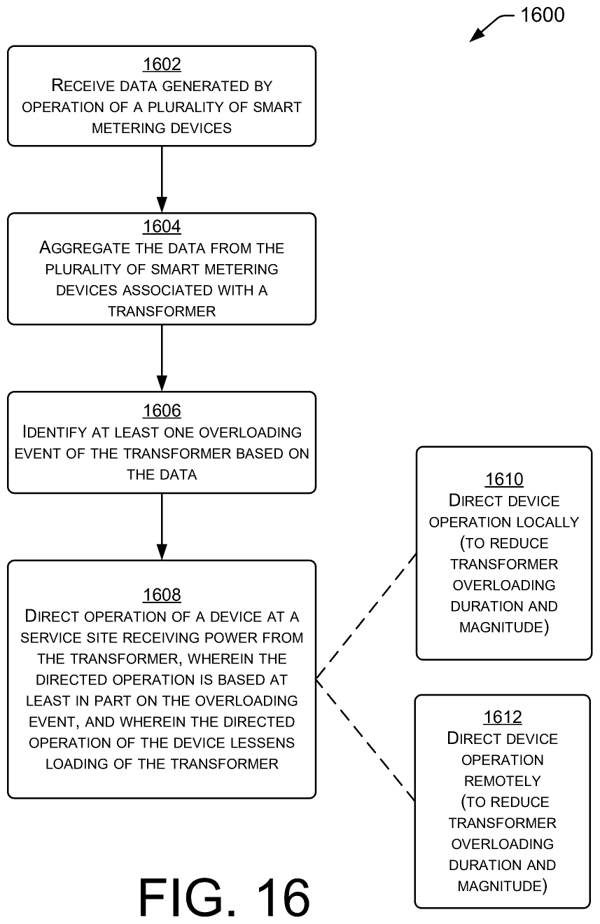

FIG. 16 shows a fourth example method 1600 by which customer sites may be selected and their loads managed to reduce transformer overloading. At block 1602, data generated by operation of a plurality of smart metering devices is received. In a first example seen in FIG. 4A, data may be received locally by the system 428 for transformer protection using distributed energy resources. In this system, device (e.g., EV charger) management is handled locally, to reduce transformer overloading. At a second or alternative example seen in FIG. 4A, data is received remotely by the system 430 operating on server(s) 402. In this system, device (e.g., EV charger) management is handled remotely, to reduce transformer overloading. The remote actions may include instructions, sent by a remote server to control EV charger(s) timing, wattage, and/or other factors. At block 1604, the data from the plurality of smart metering devices associated with a transformer are aggregated. The aggregation (or summation) indicates the load on the transformer, and allows the identification and/or prediction or forecasting of transformer overloading events, duration, magnitude (e.g., how many watts over rating), etc. At block 1606, an overloading event of the transformer is identified, based on the data. The identification may include a current overloading condition, or a forecasted overloading condition. The forecasting may be made by algorithm, model, artificial intelligence, etc. At block 1608, operation of a device at a service site receiving at least some power from the transformer is directed and/or controlled. In an example, the directed operation is based at least in part on the recognition or forecast of the overloading event. In the example, the directed operation of the device is an EV charger, and changes to, or instructions regarding, its operation lessens loading and/or overloading of the transformer.

At block 1610, operation of the device (e.g., EV charger) is directed locally to reduce transformer overloading duration and magnitude. In an example of local direction, communication between smart electricity meters may result in an EV charging plan for a number of EV chargers at a number of service sites associated with a respective number of smart electricity meters. Accordingly, instructions would be sent to the EV chargers at the service sites of the transformer, and techniques such as staggering charging times, throttling charging wattages, and others, could reduce and/or eliminate transformer overloading.

At block 1612, operation of the device (e.g., EV charger) is directed remotely to reduce transformer overloading duration and magnitude. In an example of remote direction, one or more EV chargers receiving power from the transformer act responsively to instructions sent by a remote server, such as a server associated with the manufacturer of the EV charger and/or EV vehicle. The instructions can be based on the at least one transformer overloading event, and may result from operation of, or reference to, a schedule, a model, an algorithm, etc. In an example, a plurality of actual and/or forecast transformer overloading events can be used to formulate a schedule, a model, or software object to control operation of the EV charger.

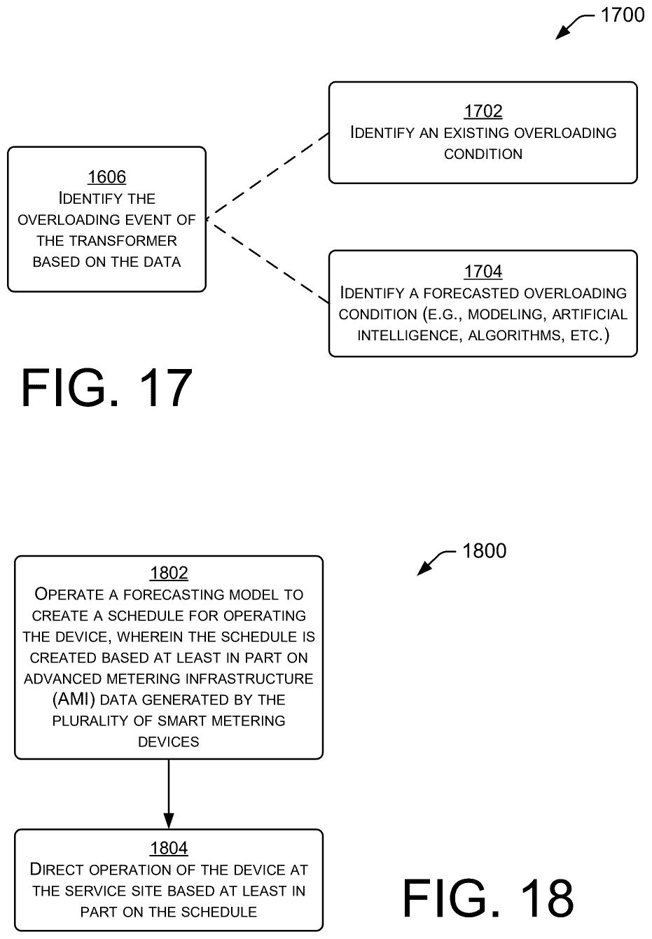

FIG. 17 shows an example method 1700 for identification of overloading events, including existing transformer overloading, and forecasted transformer overloading. Accordingly, method 1700 shows two tools that may be utilized in making the identification of block 1606 of FIG. 16. In the example, the tools (the identification of existing overloading conditions and the identification of forecasted transformer overloading conditions) that may be used (individually or collectively) to formulate an EV charging schedule or model. At block 1702, one or more existing overloading conditions are identified. At block 1704, a forecasted overloading condition is identified. In examples, the identification may be made by modeling, artificial intelligence, algorithms, etc. The identification may include past overloading conditions, times, magnitudes, etc., to thereby predict future such transformer overloading conditions.

FIG. 18 shows example operation 1800 of a forecasting model, device (e.g., EV chargers) scheduling, and device operation according to a schedule configured to reduce transformer overloading. At block 1802, a forecasting model is operated to create a schedule for operating the device. In an example, a schedule is created based at least in part on advanced metering infrastructure (AMI) data generated by the plurality of smart metering devices. At block 1804, operation of the device (e.g., EV charger) at the service site is directed based at least in part on the schedule.

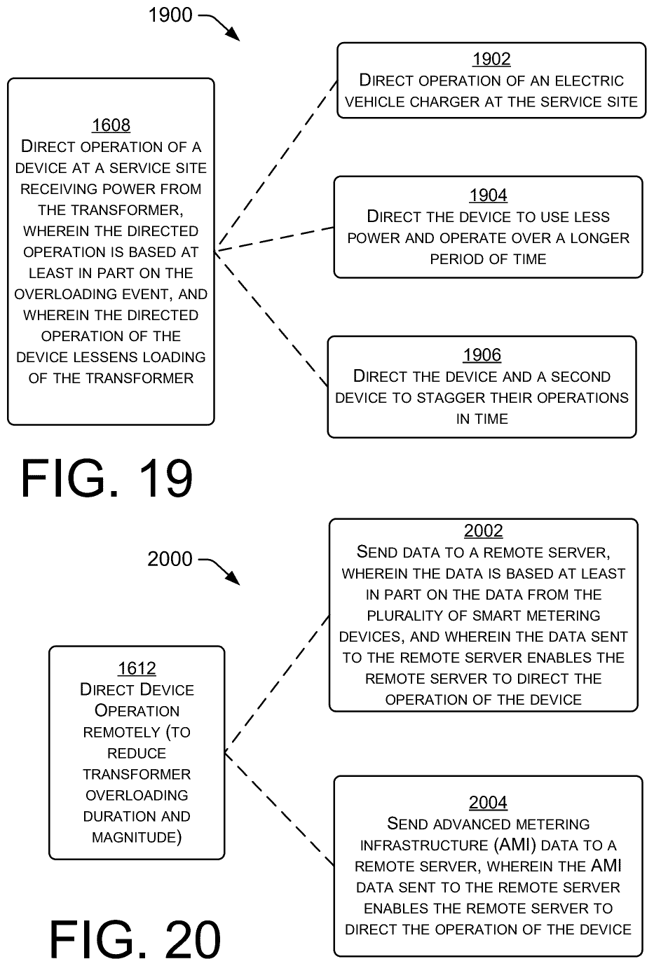

FIG. 19 shows example techniques 1900 for directing operation of device(s) to reduce transformer overloading. Accordingly, techniques 1900 show three examples by which the action of block 1608 of FIG. 16 may be performed, and by which a device may be directed to operate at a service site to lessen or eliminate transformer overload. At block 1902, operation of an EV charger at the service site is directed. Thus, while any large load device may be selected for management to reduce transformer overloading, selection of an EV charger is particularly effective. EV charging is particularly amenable to time-shifting, staggering with the operation of other EV chargers, and tolerant of lower wattage charging over longer times. At block 1904, the device (e.g., EV charger) may be directed to use less power and operate over a longer period of time. In this example, two EV chargers may be operated simultaneously at lower wattages, so that different customers are treated similarly. At block 1906, the operation of first and second devices—e.g., EV chargers—may be staggered in time. In an example, if a model suggests that a first EV will be used before a second EV, then the first EV can be charged before the second EV.

FIG. 20 shows example techniques 2000 for indirectly managing operation of device(s) to reduce transformer overloading. Accordingly, techniques 2000 show two examples by which the action of block 1612 of FIG. 16 may be performed, and by which a remote device (e.g., a server) may be sent data, thereby allowing the remote device to direct operation of devices at service sites to lessen transformer overloading. At block 2002, data is sent to a remote server. In an example, the data is based at least in part on the data from the plurality of smart metering devices. The data is sufficient to enable the remote server to direct the operation of device(s) at service sites of the transformer to reduce or eliminate overloading at the transformer. The data may include consumption data from a plurality of smart metering devices measuring power sent by the transformer. At block 2004, advanced metering infrastructure (AMI) data is sent to a remote server. In an example, the AMI data sent to the remote server enables the remote server to direct the operation of device(s), such as EV chargers.

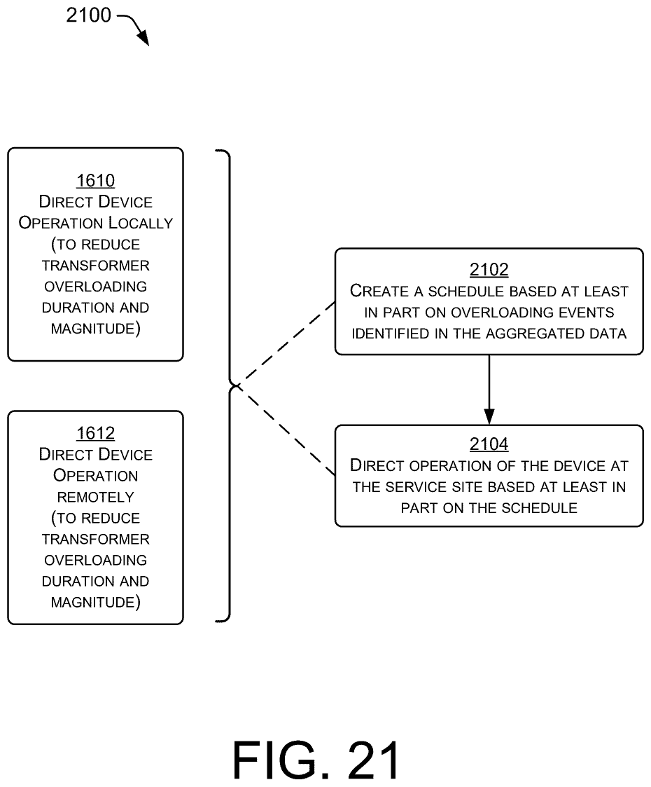

FIG. 21 shows an example method 2100 for schedule creation and device management to reduce transformer overloading. Accordingly, method 2100 shows two techniques by which the action of blocks 1610 and/or 1612 of FIG. 16 may be performed, and by which a schedule of EV charger operation may be created and used to direct operation of one or more EV chargers at one or more service sites. In a further example of the method 2100, a battery energy storage system (BESS) may be charged and controlled in a manner similar to the charging of an EV using electric vehicle supply (i.e., charging) equipment. At block 2102, a schedule is created—e.g., a schedule based at least in part on overloading events identified in the aggregated data. The schedule may be based on forecasted transformer overloading events, and designed to prevent the occurrence of such events by instructing EV chargers at one or more customer service sites to change charging times, wattages, or other factors to prevent a forecasted overload. In an example, adherence to the schedule of EV charger operation removes forecasted transformer overloads from the forecast.

### Example Systems, Devices, and Methods

The following examples of identifying at-risk low-voltage grid assets are expressed as numbered clauses. While the examples illustrate a number of possible configurations and techniques, they are not meant to be an exhaustive listing of the systems, methods, and/or techniques described herein.

1. A method, comprising: receiving advanced metering infrastructure (AMI) data from a plurality of smart metering devices; disaggregating the AMI data to identify electric vehicle (EV) charging data; identifying EV charging patterns within the EV charging data; determining a subset of the AMI data associated with a transformer; determining, based at least in part on the subset of the AMI data, a load on the transformer; comparing the load of the transformer to a rated load of the transformer to identify overloading events wherein the transformer is overloaded; and determining a correlation between the overloading events and the EV charging patterns.

2. The method of clause 1, wherein disaggregating AMI data, comprises: distinguishing electricity consumption by EV chargers from other electricity consumption over a service area comprising smart meters that are supplied power by the transformer.

3. The method of clause 1, wherein identifying the EV charging patterns comprises identifying an EV charging pattern, and wherein the EV charging pattern comprises: identified charging times; and identified charging power or energy used during the identified charging times.

4. The method of clause 1, wherein: determining a subset of the AMI data associated with a transformer comprises using topology data to determine the subset of AMI data associated with a transformer; and determining the load on the transformer comprises summing a load measured by each smart meter of the subset of smart meters to determine the load of the transformer.

5. The method of clause 1, additionally comprising: determining if a transformer overload condition occurred concurrently with one or more EV charging events, wherein the determining is based at least in part on the EV charging data.

6. The method of clause 1, additionally comprising: instructing one or more EV charging devices to change respective charging patterns to reduce the correlation between the overloading events and the EV charging patterns.

7. The method of clause 1, additionally comprising: ranking customer sites supplied power by the transformer by EV charging activity; and instructing one or more EV charging devices to change respective charging patterns based at least in part on the ranking.

8. The method of clause 1, additionally comprising: identifying changes to the EV charging patterns that would lessen at least one of: a time the transformer is overloaded; or a wattage by which the transformer is overloaded.

9. The method of clause 1, additionally comprising: identifying changes to EV charging times associated with at least one customer site of the transformer to reduce variance of a load on the transformer.

The method of clause 1, additionally comprising one or more of, or any combination of, or all of, the preceding clauses.

10. A device, comprising: a processor; one or more memory devices in communication with the processor; and statements, defined in the one or more memory devices, which when executed by the processor to perform actions comprising: receiving advanced metering infrastructure (AMI) data from a plurality of smart metering devices; disaggregating the AMI data to identify electric vehicle (EV) charging data; identifying EV charging patterns within the EV charging data; determining a subset of the AMI data associated with a transformer; determining, based at least in part on the subset of the AMI data, a load on the transformer; comparing the load of the transformer to a rated load of the transformer to identify overloading events wherein the transformer is overloaded; and determining a correlation between the overloading events and the EV charging patterns.

11. The device of clause 10, wherein disaggregating AMI data, comprises: distinguishing electricity consumption by EV chargers from other electricity consumption over a service area comprising smart meters that are supplied power by the transformer.

12. The device of clause 10, wherein identifying the EV charging patterns comprises identifying an EV charging pattern, comprising: identified charging times; and identified charging power or energy used during the identified charging times.

13. The device of clause 10, wherein: determining a subset of the AMI data associated with a transformer comprises using topology data to determine the subset of AMI data associated with a transformer; and determining the load on the transformer comprises summing a load measured by each smart meter of the subset of smart meters to determine the load of the transformer.

14. The device of clause 10, wherein the actions additionally comprise: determining if a transformer overload condition occurred concurrently with an EV charging event, wherein the determining is based at least in part on the EV charging data.

15. The device of clause 10, wherein the actions additionally comprise: instructing one or more EV charging devices to change respective charging patterns to reduce the correlation between the overloading events and the EV charging patterns.

16. The device of clause 10, wherein the actions additionally comprise: ranking customer sites supplied power by the transformer by EV charging activity; and instructing one or more EV charging devices to change respective charging patterns based at least in part on the ranking.

17. The device of clause 10, wherein the actions additionally comprise: identifying changes to the EV charging patterns that would lessen at least one of: a time the transformer is overloaded; or a wattage by which the transformer is overloaded.

18. The device of clause 10, wherein identifying changes to the EV charging patterns comprises: identifying EV charging times associated with at least one customer site of the transformer to reduce variance of a load on the transformer.

The device of clause 10, additionally comprising one or more of, or any combination of, or all of, the preceding clauses.

19. One or more non-transitory computer-readable media storing computer-executable instructions that, when executed by one or more processors, configure a computing device to perform actions comprising: receiving advanced metering infrastructure (AMI) data from a plurality of smart metering devices; disaggregating the AMI data to identify electric vehicle (EV) charging data; identifying EV charging patterns within the EV charging data; determining a subset of the AMI data associated with a transformer; determining, based at least in part on the subset of the AMI data, a load on the transformer; comparing the load of the transformer to a rated load of the transformer to identify overloading events wherein the transformer is overloaded; and determining a correlation between the overloading events and the EV charging patterns.

20. The one or more computer-readable media of clause 19, wherein identifying the EV charging patterns comprises identifying an EV charging pattern, and wherein the EV charging pattern comprises: identified charging times; and identified charging power or energy used during the identified charging times.

21. The one or more computer-readable media of clause 19, wherein: determining a subset of the AMI data associated with a transformer comprises using topology data to determine the subset of AMI data associated with a transformer; and determining the load on the transformer comprises summing a load measured by each smart meter of the subset of smart meters to determine the load of the transformer.

22. The one or more computer-readable media of clause 19, wherein the actions additionally comprise: determining if a transformer overload condition occurred concurrently with an EV charging event, wherein the determining is based at least in part on the EV charging data.

23. The one or more computer-readable media of clause 19, wherein the actions additionally comprise: instructing one or more EV charging devices to change respective charging patterns to reduce the correlation between the overloading events and the EV charging patterns.

The one or more computer-readable media of clause 19, additionally comprising one or more of, or any combination of, or all of, the preceding clauses.

1. A method of protecting a transformer from an overload event, comprising: receiving data generated by operation of a plurality of smart metering devices; aggregating the data from the plurality of smart metering devices associated with the transformer; identifying at least one overloading event of the transformer based on the data; and directing operation of a device at a service site receiving at least some power from the transformer, wherein the directed operation is based at least in part on the at least one overloading event, and wherein the directed operation of the device lessens loading of the transformer.

2. The method of clause 1, wherein identifying the at least one overloading event comprises: identifying an existing overloading condition.

3. The method of clause 1, wherein identifying the at least one overloading event comprises: identifying a forecasted overloading condition.

4. The method of clause 1, wherein directing operation of the device at the service site comprises: directing operation of an electric vehicle charger at the service site.

5. The method of clause 1, wherein directing operation of the device at the service site comprises: directing the device to use less power and operate over a longer period of time.

6. The method of clause 1, wherein directing operation of the device at the service site comprises: directing the device and a second device to stagger their operations in time.

7. The method of clause 1, additionally comprising: sending data to a remote server, wherein the data is sent responsive to the at least one overloading event, and wherein the data sent to the remote server enables the remote server to direct the operation of the device.

8. The method of clause 1, additionally comprising: sending advanced metering infrastructure (AMI) data to a remote server, wherein the AMI data sent to the remote server enables the remote server to direct the operation of the device.

9. The method of clause 1, additionally comprising: creating a schedule based at least in part on overloading events identified in the aggregated data; and directing operation of the device at the service site based at least in part on the schedule.

The method of clause 1, additionally comprising one or more of, or any combination of, or all of, the preceding clauses.

10. A system, comprising: a processor; one or more memory devices in communication with the processor; and statements, defined in the one or more memory devices, which when executed by the processor perform actions comprising: receiving data generated by operation of a plurality of smart metering devices; aggregating the data from the plurality of smart metering devices associated with a transformer; identifying at least one overloading event of the transformer based on the data; and directing operation of a device at a service site receiving at least some power from the transformer, wherein the directed operation is based at least in part on the at least one overloading event, and wherein the directed operation of the device lessens loading of the transformer.

11. The system of clause 10, wherein the actions additionally comprise: creating a schedule based at least in part on overloading events identified in the aggregated data; and directing operation of the device at the service site based at least in part on the schedule.

12. The system of clause 10, wherein the actions additionally comprise: sending data to a remote server, wherein the data is based at least in part on the data from the plurality of smart metering devices, and wherein the data sent to the remote server enables the remote server to direct the operation of the device.

13. The system of clause 10, wherein the actions additionally comprise: sending advanced metering infrastructure (AMI) data to a remote server, wherein the AMI data sent to the remote server enables the remote server to direct the operation of the device.

14. The system of clause 10, wherein the actions additionally comprise: operating a forecasting model to create a schedule for operating the device, wherein the schedule is created based at least in part on advanced metering infrastructure (AMI) data generated by the plurality of smart metering devices, wherein directing operation of the device at the service site based at least in part on the schedule.

15. The system of clause 10, wherein identifying the overloading event comprises: identifying an existing overloading condition; or identifying a forecasted overloading condition.

The system of clause 10, additionally comprising one or more of, or any combination of, or all of, the preceding clauses.

16. One or more non-transitory computer-readable media storing computer-executable instructions that, when executed by one or more processors, configure a computing device to perform actions to protect a transformer from an overload event, the actions comprising: receiving data generated by operation of a plurality of smart metering devices; aggregating the data from the plurality of smart metering devices associated with the transformer; identifying at least one overloading event of the transformer based on the data; and directing operation of a device at a service site receiving at least some power from the transformer, wherein the directed operation is based at least in part on the at least one overloading event, and wherein the directed operation of the device lessens loading of the transformer.

17. The one or more computer-readable media of clause 16, wherein identifying the at least one overloading event comprises: identifying an existing overloading condition.

18. The one or more computer-readable media of clause 16, wherein identifying the at least one overloading event comprises: identifying a forecasted overloading condition.

19. The one or more computer-readable media of clause 16, wherein directing operation of the device at the service site comprises: directing operation of an electric vehicle charger at the service site.

20. The one or more computer-readable media of clause 16, wherein directing operation of the device at the service site comprises: directing the device to use less power and operate over a longer period of time.

The one or more computer-readable media of clause 16, additionally comprising one or more of, or any combination of, or all of, the preceding clauses.

### Conclusion

Although the subject matter has been described in language specific to structural features and/or methodological actions, it is to be understood that the subject matter defined in the appended claims is not necessarily limited to the specific features or actions described. Rather, the specific features and actions are disclosed as exemplary forms of implementing the claims.

The words comprise, comprises, and/or comprising, when used in this specification and/or claims do not preclude the presence or addition of one or more other features, devices, techniques, and/or components and/or groups thereof.

What is claimed is:

1. A method, comprising:
receiving advanced metering infrastructure (AMI) data from a plurality of smart metering devices;
disaggregating the AMI data to identify electric vehicle (EV) charging data;
identifying EV charging patterns within the EV charging data;
determining a subset of the AMI data associated with a transformer;
determining, based at least in part on the subset of the AMI data, a load on the transformer;
comparing the load of the transformer to a rated load of the transformer to identify overloading events wherein the transformer is overloaded; and
determining a correlation between the overloading events and the EV charging patterns.

2. The method of claim 1, wherein disaggregating AMI data, comprises:
distinguishing electricity consumption by EV chargers from other electricity consumption over a service area comprising smart meters that are supplied power by the transformer.

3. The method of claim 1, wherein identifying the EV charging patterns comprises identifying an EV charging pattern, and wherein the EV charging pattern comprises:
identified charging times; and
identified charging power or energy used during the identified charging times.

4. The method of claim 1, wherein:
determining a subset of the AMI data associated with a transformer comprises using topology data to determine the subset of AMI data associated with a transformer; and
determining the load on the transformer comprises summing a load measured by each smart meter of the subset of smart meters to determine the load of the transformer.

5. The method of claim 1, additionally comprising:
determining if a transformer overload condition occurred concurrently with one or more EV charging events, wherein the determining is based at least in part on the EV charging data.

6. The method of claim 1, additionally comprising:
instructing one or more EV charging devices to change respective charging patterns to reduce the correlation between the overloading events and the EV charging patterns.

7. The method of claim 1, additionally comprising:
ranking customer sites supplied power by the transformer by EV charging activity; and
instructing one or more EV charging devices to change respective charging patterns based at least in part on the ranking.

8. The method of claim 1, additionally comprising:
identifying changes to the EV charging patterns that would lessen at least one of:
a time the transformer is overloaded; or
a wattage by which the transformer is overloaded.

9. The method of claim 1, additionally comprising:
identifying changes to EV charging times associated with at least one customer site of the transformer to reduce variance of a load on the transformer.

10. A device, comprising:
a processor;
one or more memory devices in communication with the processor; and
statements, defined in the one or more memory devices, which when executed by the processor to perform actions comprising:
receiving advanced metering infrastructure (AMI) data from a plurality of smart metering devices;
disaggregating the AMI data to identify electric vehicle (EV) charging data;
identifying EV charging patterns within the EV charging data;
determining a subset of the AMI data associated with a transformer;
determining, based at least in part on the subset of the AMI data, a load on the transformer;
comparing the load of the transformer to a rated load of the transformer to identify overloading events wherein the transformer is overloaded; and
determining a correlation between the overloading events and the EV charging patterns.

11. The device of claim 10, wherein disaggregating AMI data, comprises:
distinguishing electricity consumption by EV chargers from other electricity consumption over a service area comprising smart meters that are supplied power by the transformer.

12. The device of claim 10, wherein identifying the EV charging patterns comprises identifying an EV charging pattern, comprising:
identified charging times; and
identified charging power or energy used during the identified charging times.

13. The device of claim 10, wherein:
determining a subset of the AMI data associated with a transformer comprises using topology data to determine the subset of AMI data associated with a transformer; and
determining the load on the transformer comprises summing a load measured by each smart meter of the subset of smart meters to determine the load of the transformer.

14. The device of claim 10, wherein the actions additionally comprise:
determining if a transformer overload condition occurred concurrently with an EV charging event, wherein the determining is based at least in part on the EV charging data.

15. The device of claim 10, wherein the actions additionally comprise:
instructing one or more EV charging devices to change respective charging patterns to reduce the correlation between the overloading events and the EV charging patterns.

16. The device of claim 10, wherein the actions additionally comprise:
ranking customer sites supplied power by the transformer by EV charging activity; and
instructing one or more EV charging devices to change respective charging patterns based at least in part on the ranking.

17. The device of claim 10, wherein the actions additionally comprise:
identifying changes to the EV charging patterns that would lessen at least one of:
a time the transformer is overloaded; or
a wattage by which the transformer is overloaded.

18. The device of claim 10, wherein identifying changes to the EV charging patterns comprises:
identifying EV charging times associated with at least one customer site of the transformer to reduce variance of a load on the transformer.

19. One or more non-transitory computer-readable media storing computer-executable instructions that, when executed by one or more processors, configure a computing device to perform actions comprising:
receiving advanced metering infrastructure (AMI) data from a plurality of smart metering devices;
disaggregating the AMI data to identify electric vehicle (EV) charging data;
identifying EV charging patterns within the EV charging data;
determining a subset of the AMI data associated with a transformer;
determining, based at least in part on the subset of the AMI data, a load on the transformer;
comparing the load of the transformer to a rated load of the transformer to identify overloading events wherein the transformer is overloaded; and
determining a correlation between the overloading events and the EV charging patterns.

20. The one or more computer-readable media of claim 19, wherein identifying the EV charging patterns comprises identifying an EV charging pattern, and wherein the EV charging pattern comprises:
identified charging times; and
identified charging power or energy used during the identified charging times.

21. The one or more computer-readable media of claim 19, wherein:
determining a subset of the AMI data associated with a transformer comprises using topology data to determine the subset of AMI data associated with a transformer; and
determining the load on the transformer comprises summing a load measured by each smart meter of the subset of smart meters to determine the load of the transformer.

22. The one or more computer-readable media of claim 19, wherein the actions additionally comprise:
determining if a transformer overload condition occurred concurrently with an EV charging event, wherein the determining is based at least in part on the EV charging data.

23. The one or more computer-readable media of claim 19, wherein the actions additionally comprise:
instructing one or more EV charging devices to change respective charging patterns to reduce the correlation between the overloading events and the EV charging patterns.
